(19) United States
(12) Patent Application Publication
(10) Pub. No.: US 2012/0133520 A1
(43) Pub. Date: May 31, 2012

(54) COMPUTER CHASSIS SYSTEM AND HARD DISK STATUS DISPLAY METHOD THEREOF

(75) Inventors: Po-Chung CHANG, TAIPEI CITY (TW); Chen-Pin LEE, TAIPEI CITY (TW); Huang-Ching WANG, TAIPEI CITY (TW)

(73) Assignee: INVENTEC CORPORATION, TAIPEI CITY (TW)

(21) Appl. No.: 12/980,345

(22) Filed: Dec. 29, 2010

(30) Foreign Application Priority Data
Nov. 30, 2010 (TW) 099141483

(51) Int. Cl. G08B 21/00; G06F 13/00

(52) U.S. Cl. 340/635; 710/110

(57) ABSTRACT

A computer system displays and controls the hard disk condition. The computer system includes a host bus adapter which detects the status of the hard disk, and the status light gives light to display the hard disk status. The baseboard management controller and the host bus adapters are set on the motherboards, in which the baseboard management controller monitors and records the status of the hard disk. The microcontroller is set on the hard disk backplane for decoding the message from the host bus adapter in order to control the displaying of the status light.

### RELATED APPLICATIONS

This application claims priority to Taiwan Application Serial Number 099141483, filed Nov. 30, 2010, which is herein incorporated by reference.

### BACKGROUND

1. Field of Invention

The present invention relates to a computer system. More particularly, the present invention relates to a computer system containing a hard disk.

2. Description of Related Art

With the flourishing development of the information, the management of a storage device becomes more important. Generally, as for the management and control of a common storage server over a hard disk (HD), a hard disk controller first detects a status of the hard disk, transmits an LED light control signal corresponding to the status of the hard disk to a complex programmable logic device (CPLD) to be decoded, and then turns on an LED light for displaying according to the signal. The complex programmable logic device is suitable for realizing various computations and combinational logics. A complex programmable logic device includes multiple programmable array logics (PAL) therein. An interconnected line among the programmable array logics may also perform programmed planning and burning. The complex programmable logic device uses such an all-in-one integrated configuration that only one complex programmable logic device is required to form a circuit which is originally formed by thousands of or even hundreds of thousands of logic gates.

However, the complex programmable logic device has a prohibitive cost, covers a large area and cannot record events occurring on a hard disk. Moreover, when a firmware is updated, a computer itself cannot be directly used to update the firmware, but assistance from other computers is required.

### SUMMARY

Therefore, an aspect of the present invention provides a computer system, which is capable of reducing a manufacturing cost and a circuit area, recording events occurring on a hard disk and self-updating a firmware.

According to an embodiment of the present invention, a computer chassis system is used to display and control a hard disk status. The computer chassis system includes at least a plurality of status lights, a hard disk backplane, a plurality of slave microcontrollers, a plurality of motherboards, a plurality of host bus adapters (HBAs), and a plurality of baseboard management controllers (BMCs). A hard disk controller of the host bus adapter detects a status of the plurality of hard disks, and the status lights are electrically connected to the hard disk backplane, so as to illuminate for displaying the status of the hard disks. The host bus adapters and the baseboard management controllers are set on the motherboards. The slave microcontrollers are set on the hard disk backplane and are electrically connected to the host bus adapters through a data signal line, so as to receive and decode a message transferred from the host bus adapters. The slave microcontrollers are connected to the status lights through a light control line and control the displaying of the lights by decoding the message transferred from the host bus adapters. The baseboard management controllers monitor and record the status of the hard disks.

In this embodiment, if there are only three motherboards but there are 24 status lights to be controlled, each motherboard needs to control additional status lights. In this case, the motherboards can transmit a light control signal to a master microcontroller through a second control signal line, and the master microcontroller can transmit the light control signal to a slave microcontroller in to charge. In this way, the additional status lights can be controlled.

Another aspect of the present invention provides a hard disk status display method of a computer system. The method is capable of reducing a manufacturing cost and a circuit area, recording events occurring on a hard disk and updating a firmware under the current operating system.

According to another embodiment of the present invention, a hard disk status display method of a computer system is used to display a status of a plurality of hard disks by controlling a plurality of status lights. The hard disk status display method detects a status of at least one hard disk, generates a light control signal according to a detection result, decodes the light control signal, and turns on or turns off a status light according to the decoded light control signal, so as to display the status of the hard disk.

The computer system and the hard disk status display method thereof in the above embodiments replace a complex programmable logic device with a slave microcontroller to decode a hard disk status, thereby being capable of reducing a manufacturing cost and a circuit area, recording events occurring on a hard disk and updating a firmware under the current operating system.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a block diagram of a computer system according to an embodiment of the present invention;

FIG. 2 is a block diagram of a computer system according to another embodiment of the present invention; and

FIG. 3 is a flow chart of a hard disk status display method of a computer system according to an embodiment of the present invention.

### DETAILED DESCRIPTION

The computer system and the hard disk status display method thereof in the following embodiments replace a complex programmable logic device with a slave microcontroller to decode a hard disk status, thereby being capable of reducing a manufacturing cost and a circuit area, recording events occurring on a hard disk and self-updating a firmware.

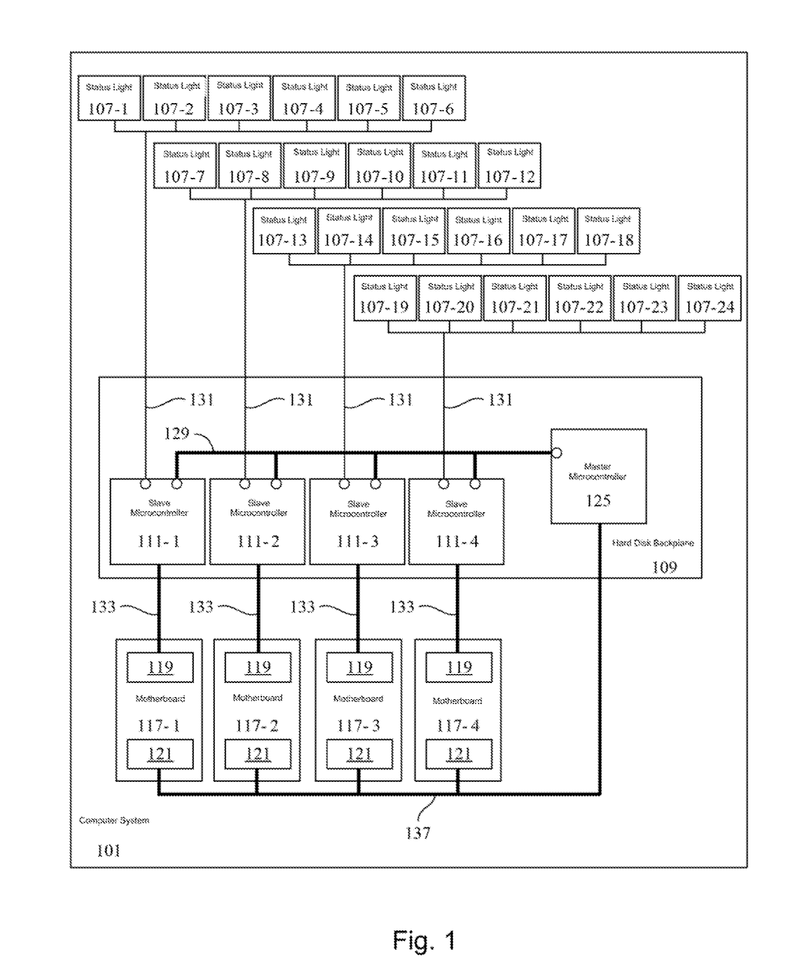

Referring to FIG. 1, FIG. 1 is a block diagram of a computer system according to an embodiment of the present invention. The computer system 101 can display and control a hard disk status, wherein the computer system includes a hard disk 105 (not shown), status lights 107-1 to 107-24, a hard disk backplane 109, and motherboards 117-1 to 117-4. A host bus adapter 119 is set on the motherboards 117-1 to 117-4 for detecting a status of multiple hard disks, so as to determine whether the hard disks act normally.

Multiple slave microcontrollers 111-1 to 111-4 are set on the hard disk backplane 109. The slave microcontrollers 111-1 to 111-4 are electrically connected to the host bus adapter 119 through a data signal line 133, so as to receive and decode a message from the host bus adapter 119. The data signal line 133 may use a Serial General Purpose Input/Output (SGPIO) or Inter-Integrated Circuit (I2C) communication protocol. The slave microcontrollers 111-1 to 111-4 are electrically connected to the status lights 107-1 to 107-24 through a light control line 131, so as to control the status lights 107 to make them illuminate for displaying the status of the hard disks. The status lights 107 can be implemented by a light emitting diode. For example, a light emitting diode can remain on or off to show whether a hard disk breaks down, and can also blink fast or slowly to show whether the hard disk is accessing data. Moreover, other light control manners can be used to show a plug-in or pull-out status of the hard disk.

The slave microcontrollers 111-1 to 111-4 can be implemented by a single 8051 chip or some other single chip, which is economical and smaller than a complex programmable logic device in area and thus can reduce the manufacturing cost and the occupation area of the computer system 101. Moreover, the slave microcontrollers 111-1 to 111-4 in a single-chip form can decode many types of signals, e.g. a Serial General Purpose Input/Output (SGPIO) signal and an Inter-Integrated Circuit (I2C) signal. Compared with a complex programmable logic device capable of decoding only one type of signal, the slave microcontrollers 111-1 to 111-4 implemented by the single chip are more suitable for various types of hard disk controllers 103, thereby increasing the flexibility of circuit arrangement.

Multiple host bus adapters (HBAs) 119 and multiple baseboard management controllers (BMCs) 121 are set on the motherboards 117-1 to 117-4, wherein a host bus adapter 119 and a baseboard management controller 121 are set on each of the motherboards 117-1 to 117-4. The host bus adapter 119 accesses a hard disk and controls the status lights 107-1 to 107-24 according to a status of the hard disk.

The baseboard management controller 121 monitors and records the status of the hard disks, and is responsible for monitoring various statuses of the computer system 101, e.g. monitoring and recording a temperature and various transmission errors of the computer system 101, so as to help a monitoring operator to manage and maintain the computer system 101, or to provide a basis for improving the computer system 101. The baseboard management controller 121 mainly includes a microcontroller and a firmware embedded in the baseboard management controller, and can act as an interface between a software and a hardware to work across different firmware and hardware platforms.

For example, the baseboard management controller 121 can initiatively provide some functions, such as monitoring a system status of a software/hardware of the computer system, recording an event log, controlling a system reboot, generating an alarm for an event automatically, and performing an automatic system control (e.g. power-off). Through the baseboard management controller 121, a firmware of the slave microcontrollers 111 can be directly updated, thereby increasing the convenience of updating.

The computer system 101 further includes a master microcontroller 125. The master microcontroller 125 is electrically connected to each of the slave microcontrollers 111-1 to 111-4 through a first control signal line 129, so as to transmit a data and an instruction to the slave microcontrollers 111-1 to 111-4, thereby controlling the slave microcontrollers 111-1 to 111-4. The master microcontroller 125 is also electrically connected to the baseboard management controller 121 through a second signal line 137, so as to receive a data from and transmit a data to the baseboard management controller 121. When a firmware of the master microcontroller 125 is to be updated, the baseboard management controller 121 can transmit the firmware to the master microcontroller 125, so as to update the master microcontroller 125 itself. When a firmware of the slave microcontrollers 111-1 to 111-4 is to be updated, the baseboard management controller 121 transmits the firmware to the master microcontroller 125, and then the master microcontroller 125 updates the firmware of each of the slave microcontrollers 111-1 to 111-4 through the first control signal line 129. In this way, the problem that an external computer is required for a conventional complex programmable logic device to update a firmware is solved.

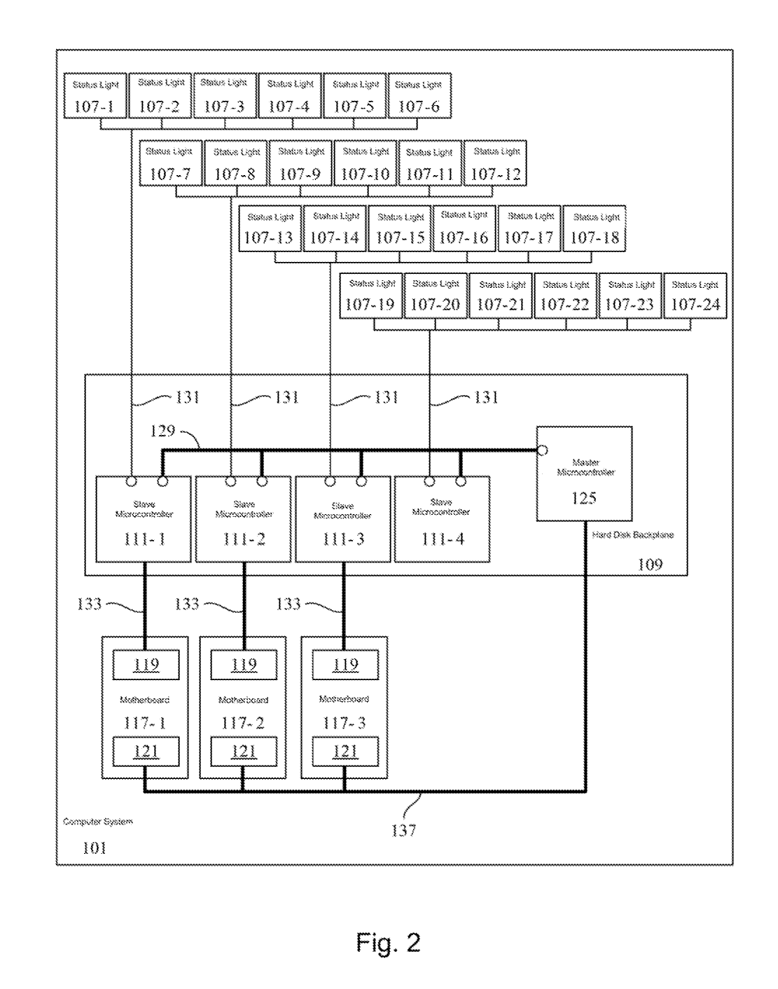

Referring to FIG. 2, FIG. 2 is a block diagram of the computer system according to another embodiment of the present invention. In view of product planning, when only three motherboards 117-1 to 117-3 are used in the same architecture, the motherboards 117-1 to 117-3 control the status lights 107-1 to 107-24 through two slave microcontrollers 111. In this case, the motherboards 117-1 to 117-3 transmit a signal for turning on a light to the master microcontroller 125 through the second control signal line 137, and the master microcontroller 125 transmits the signal to a slave microcontroller 111 in charge of turning on a status light 107 according to the status light 107 to be turned on. For example, when there are four motherboards 117-1 to 117-4 (FIG. 1), four slave microcontrollers 111-1 to 111-4 and the status lights 107-1 to 107-24, the motherboard 117-1 is directly connected to the slave microcontroller 111-1 and the slave microcontroller 111-1 is directly connected to the status lights 107-1 to 107-6. Thus, the motherboard 117-1 and the slave microcontroller 111-1 control only the status lights 107-1 to 107-6. However, when only three motherboards 117-1 to 117-3 are used (FIG. 2), the hard disk backplane 109 remains unchanged and thus the connection manner between the slave microcontrollers 111-1 to 111-4 and the status lights 107-1 to 107-24 remains unchanged.

Since there are only three motherboards 117-1 to 117-3 but there are 24 status lights 107-1 to 107-24 to be controlled, each motherboard needs to control 8 status lights. In this way, the motherboard 117-1 needs to control the status lights 107-1-107-8, wherein a manner of controlling the status lights 107-1-107-6 is the same as the preceding one and no further description will be given herein. The motherboard 117-1 is not directly connected to the slave microcontroller 111-2 for controlling the status lights 107-7 and 107-8. Thus, if the status lights 107-7 and 107-8 are to be controlled, a light control signal is transmitted to the master microcontroller 125 through the second control signal line 137 and then transmitted by the master microcontroller 125 to the slave microcontroller 111-2 in charge. Likewise, when the motherboard 117-2 wants to control the status light 107-14, a light control signal is also transmitted to the master microcontroller 125 through the second control signal line 137 and then transmitted by the master microcontroller 125 to the slave microcontroller 111-3 in charge of the status light 107-14. In this way, the status light 107-14 can be controlled.

Although a status of a hard disk can be known and also displayed in a conventional architecture, a user cannot know what is happening but needs to query the motherboards (MBs) one by one to find out whether something is recorded. Since each motherboard has a baseboard management controller for recording a temperature change and an error that occurs, this embodiment of the present invention can use a second signal control signal. When a hard disk is plugged in or pulled out, a message is transmitted to a baseboard management controller on a corresponding motherboard through the second signal control signal. The status of the hard disk is initiatively recorded by using a function of the baseboard management controller, so as to inform the user.

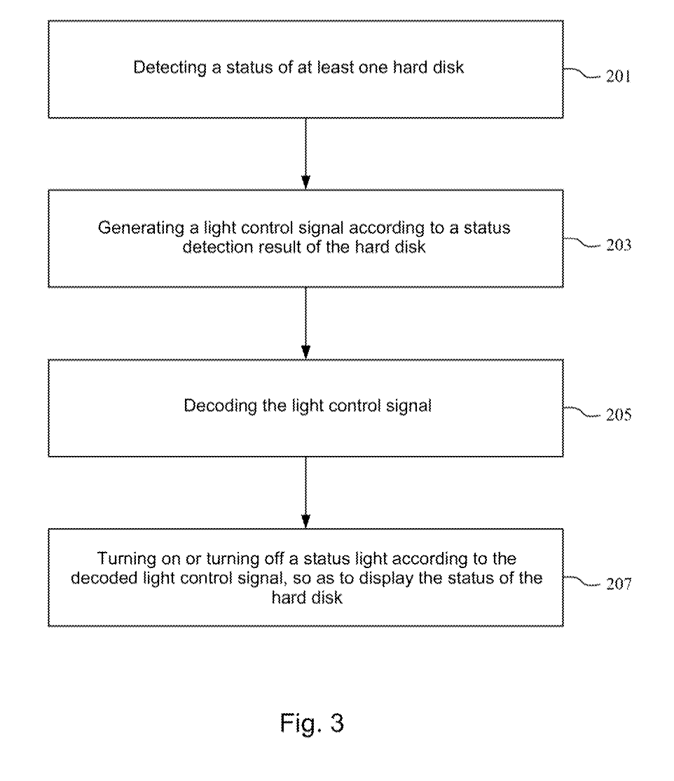

Referring to FIG. 3, FIG. 3 is a flow chart of a hard disk status display method of a computer system according to an embodiment of the present invention. The hard disk status display method of the computer system displays a status of plural hard disks by controlling plural status lights. The hard disk status display method detects a status of at least one hard disk (step 201), generates a light control signal (step 203) according to a detection result, decodes the light control signal (step 205), and turns on or turns off a status light according to the decoded light control signal (step 207). For example, when it is found that a certain hard disk breaks down, the light control signal is sent out to turn off a status light corresponding to the hard disk, so as to inform a user that the hard disk breaks down.

The computer system and the hard disk status display method thereof in the above embodiments replace a complex programmable logic device with a slave microcontroller to decode a hard disk status, which can increase the convenience of updating a firmware and are applicable to different product planning.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A computer system, for displaying and controlling a hard disk status, comprising:
a plurality of motherboards;
a plurality of status lights;
a plurality of host bus adapters set on the motherboards respectively, wherein the host bus adapters access a plurality of hard disks and controls the status lights according to a status of the hard disks;
a plurality of baseboard management controllers set on the motherboards respectively;
a hard disk backplane;
a plurality of slave microcontrollers set on the hard disk backplane and electrically connected to the host bus adapters respectively, wherein the slave microcontrollers are also electrically connected to the status lights and control the status lights by decoding a message transferred from the host bus adapters; and
a master microcontroller electrically connected to the slave microcontrollers and the baseboard management controllers.

2. The computer system of claim 1, further comprising a first control signal line, electrically connected between the slave microcontrollers and the master microcontroller, for transferring a data and an instruction to the slave microcontrollers to control the slave microcontrollers.

3. The computer system of claim 1, further comprising a first control signal line, electrically connected between the slave microcontrollers and the master microcontroller, wherein the master microcontroller updates a firmware of the slave microcontrollers through the first control signal line.

4. The computer system of claim 1, further comprising a light control line, electrically connected between the slave microcontrollers and the status lights, for helping the slave microcontrollers to control the status lights to make them illuminate for displaying the status of the hard disks.

5. The computer system of claim 1, further comprising a plurality of data signal lines, electrically connected between the host bus adapters and the slave microcontrollers, wherein the slave microcontrollers receive and decode the message transferred from the host bus adapters through the data signal lines.

6. The computer system of claim 5, wherein the data signal lines use a Serial General Purpose Input/Output (SGPIO) or Inter-Integrated Circuit (I2C) communication protocol.

7. A hard disk status display method of a computer system, for displaying a status of a plurality of hard disks by controlling a plurality of status lights, comprising:
detecting a status of at least one hard disk;
generating a light control signal according to a status detection result of the hard disk;
transmitting the light control signal to the master microcontroller;
transmitting the light control signal to the slave microcontroller;
decoding the light control signal; and
turning on or turning off a status light according to the decoded light control signal, so as to display the status of the hard disk.

8. The hard disk status display method of claim 7, further comprising: when finding that a certain hard disk breaks down, sending out the light control signal to turn off a status light corresponding to the hard disk, so as to inform a user that the hard disk breaks down.
